(19) United States
(12) Patent Application Publication
(10) Pub. No.: US 2015/0021264 A1
(43) Pub. Date: Jan. 22, 2015

(54) TREATMENT METHODS AND TREATMENT SYSTEMS FOR PLANT EFFLUENTS

(71) Applicants: Chiyoda Corporation, Yokohama-shi (JP); Toray Industries, Inc., Tokyo (JP)

(72) Inventors: Kanako Tsuda, Yokohama-shi (JP); Yusuke Shinoda, Yokohama-shi (JP); Masayo Shinohara, Yokohama-shi (JP); Kazuyuki Tejima, Yokohama-shi (JP); Atsushi Kitanaka, Otsu-shi (JP); Masahide Taniguchi, Otsu-shi (JP)

(73) Assignees: Chiyoda Corporation, Yokohama-shi (JP); Toray Industries, Inc., Tokyo (JP)

(21) Appl. No.: 14/377,529

(22) PCT Filed: Jan. 10, 2013
(86) PCT No.: PCT/JP2013/050255

§ 371 Date: Aug. 8, 2014

(30) Foreign Application Priority Data
Feb. 9, 2012 (JP) 2012-025710

(51) Int. Cl. C02F 3/12; C02F 1/00; C02F 1/04; C02F 3/30; C02F 1/44

(52) U.S. Cl. CPC C02F 3/1268; C02F 3/30; C02F 1/441; C02F 1/04; C02F 1/008; C02F 3/121; C02F 2101/30
USPC 210/605; 210/620; 210/614; 210/610; 210/202; 210/177; 210/143

(57) ABSTRACT

A plant effluent treatment method includes a mixing treatment step that mixes a microorganism activating agent into plant effluent containing organic compounds as discharged from a chemical plant, petroleum plant or petrochemical plant and discharges it as mixing treatment effluent, and an aerobic treatment step that subjects the mixing treatment effluent to aerobic biological treatment and solid-liquid separation treatment in a membrane bioreactor tank.

### TECHNICAL FIELD

This disclosure relates to treatment methods and treatment systems for plant effluent designed to improve treatment efficiency when treating plant effluent containing organic compounds using a membrane bioreactor tank.

### BACKGROUND

In recent years, it has been proposed to purify wastewater and sewage through biological treatment amid growing attention on the efficient use of water resources, particularly recycling. In this regard, a method to purify water containing organic compounds by decomposing and removing organic compounds by way of activated sludge treatment is known.

For example, International Publication WO 2003/106354 describes a three-stage treatment of reaction water from the Fischer-Tropsch process that involves distillation in the primary treatment stage, anaerobic digestion and/or aerobic digestion in the secondary treatment stage, and solid-liquid separation in the tertiary treatment stage. However, a problem has been identified in that subjecting treated water containing acidic, oxygen-containing hydrocarbons as distilled out in the primary treatment stage to biological treatment in the secondary treatment stage causes degradation in the activity of activated sludge comprising microorganisms and sludge disintegration (pulverization) and leads to fouling of the separation membrane in the tertiary treatment stage due to the presence of pulverized sludge.

Similarly, International Publication WO 2011/043144 describes an anaerobic and aerobic microorganism-based biological treatment of plant effluent containing organic compounds that involves treatment processes based on an anaerobic biological treatment tank, aerobic biological treatment tank, means of solid-liquid separation, and reverse osmosis (RO) membrane separation device. However, an anaerobic biological treatment of plant effluent sometimes generates large amounts of suspended solids (SS), and it has been observed that treated water tends to be left with residual anaerobic treatment-derived SS despite the fact that aerobic biological treatment is also provided. This leads to fouling of the separation membrane during the solid-liquid separation treatment of the effluent from aerobic biological treatment, to an increase of the cleaning frequency of the separation membrane, and makes it difficult to raise overall treatment efficiency by reducing the operational flux of the separation membrane to low levels, e.g., around 0.2 m³/m²/day.

These problems are therefore considered to be attributable to the unsuitability of plant effluent containing organic compounds for aerobic biological treatment. Moreover, treating plant effluent via a means of preliminary treatment comprising distillation, anaerobic biological treatment, and the like gives rise to problems such as a reduction in treatment efficiency due to reduced activity of aerobic microorganisms (activated sludge) and reduction in the operational flux due to fouling of the separation membrane involving large amounts of pulverized activated sludge or anaerobic treatment-derived suspended solids.

There is thus a need to provide treatment methods and treatment systems for plant effluent that improve treatment efficiency above traditional levels when treating plant effluent containing organic compounds using a membrane bioreactor tank.

### SUMMARY

We provide plant effluent treatment methods comprising at least a mixing treatment step designed to mix a microorganism activating agent into plant effluent containing organic compounds as discharged from a chemical plant, petroleum plant or petrochemical plant and discharge it as mixing treatment effluent and an aerobic treatment step designed to provide the mixing treatment effluent with aerobic biological treatment and solid-liquid separation treatment in a membrane bioreactor tank.

Our plant effluent treatment systems at least comprise a means that mix a microorganism activating agent into plant effluent containing organic compounds as discharged from a chemical plant, petroleum plant or petrochemical plant and discharge it as mixing treatment effluent and a membrane bioreactor tank designed to provide the mixing treatment effluent with aerobic biological treatment and solid-liquid separation treatment.

Our plant effluent treatment methods make it possible to minimize fouling of the separation membrane and dramatically improve the operational flux by adding a microorganism activating agent to the plant effluent containing organic compounds before providing aerobic biological treatment in a membrane bioreactor tank. Although the reason for this is not clear, we surmise that the addition of a microorganism activating agent increases the activity of the activated sludge comprising aerobic microorganisms and improves the cohesion of the activated sludge.

As the microorganism activating agent, it is preferable to use domestic wastewater as this makes it possible to activate aerobic microorganisms and improve treatment efficiency above traditional levels at no cost.

Before the mixing treatment step, it may be possible to have a preliminary treatment step designed to treat the plant effluent using a means of preliminary treatment comprising at least one method chosen from anaerobic biological treatment, distillation, wet oxidation, dilution, screen filtration, carrier filtration, sand filtration, pH control, oil removal treatment and activated carbon treatment and discharge it as preliminary treatment effluent and to feed the preliminary treatment effluent to the mixing treatment step.

The preliminary treatment step may comprise a pretreatment step designed to feed the plant effluent to an anoxic tank, decompose organic compounds through anaerobic biological treatment and discharge the effluent as pretreated water and an anaerobic treatment step designed to introduce the pretreated water into an anaerobic biological treatment tank, provide anaerobic biological treatment to further decompose the organic compounds and discharge the effluent as the preliminary treatment effluent.

The preliminary treatment step may comprise a distillation step designed to feed the plant effluent to a distillation column and separate it into treated water containing acidic, oxygen-containing hydrocarbons and organic compounds other than the acidic, oxygen-containing hydrocarbons, with the treated water containing acidic, oxygen-containing hydrocarbons discharged as the preliminary treatment effluent.

The preliminary treatment step may be configured from a distillation step designed to feed the plant effluent to a distillation column and separate it into treated water containing acidic, oxygen-containing hydrocarbons and organic compounds other than the acidic, oxygen-containing hydrocarbons and a pretreatment RO step designed to introduce the treated water containing acidic, oxygen-containing hydrocarbons into a pretreatment reverse osmosis membrane separation device and separate it into a pretreatment RO filtrate and pretreatment RO concentrate, with the pretreatment RO concentrate discharged as the preliminary treatment effluent.

Furthermore, a post-treatment RO step designed to introduce at least part of the treated water discharged from the aerobic treatment step into a post-treatment reverse osmosis membrane separation device and separate it into a post-treatment RO filtrate and post-treatment RO concentrate may be included.

It is preferable that the microorganism activating agent contain carbohydrate (sugar), fat, protein, nitrogen, phosphorus and fibrous material. It is also preferable to use an agent whose pH is 6.0-8.0, whose biochemical oxygen demand (BOD) is 60-1000 mg/l, whose total nitrogen content is 15-100 mg/l and whose total phosphorus content is 1.5-15 mg/l as the microorganism activating agent.

Our plant effluent treatment systems are capable of minimizing fouling of the separation membrane and dramatically improving the operational flux as a result of incorporating a means of mixing designed to add microorganism activating agent to the plant effluent to thereby increase the activity of the activated sludge in the membrane bioreactor tank located downstream, and improve its cohesion.

Upstream of the means of mixing, a means of preliminary treatment designed to treat the plant effluent using at least one facility chosen from an anaerobic biological treatment tank, distillation column, wet oxidation device, means of dilution, means of screen filtration, means of carrier filtration, means of sand filtration, means of pH control, means of oil removal treatment and means of activated carbon treatment and discharge it as preliminary treatment effluent may be placed.

As the means of preliminary treatment, it may be possible to have an anoxic tank designed to provide the plant effluent with anaerobic biological treatment and discharge it as pre-treated water and an anaerobic biological treatment tank designed to provide the pretreated water with further anaerobic biological treatment and discharge it as preliminary treatment effluent.

Alternatively, the means of preliminary treatment may comprise a distillation column designed to distill the plant effluent and separate it into treated water containing acidic, oxygen-containing hydrocarbons and organic compounds other than the acidic, oxygen-containing hydrocarbons. Furthermore, it may be possible to have a pretreatment reverse osmosis membrane separation device designed to separate the treated water containing acidic, oxygen-containing hydrocarbons into a pretreatment RO filtrate and pretreatment RO concentrate.

It may also be possible to place a post-treatment reverse osmosis membrane separation device designed to separate at least part of the treated water discharged from the membrane bioreactor tank into a post-treatment RO filtrate and post-treatment RO concentrate in the downstream of the membrane bioreactor tank.

### BRIEF DESCRIPTION OF THE DRAWINGS

FIG. 1 is a process flow diagram that shows an example of treatment methods and treatment systems for plant effluent.

FIG. 2 is a process flow diagram that shows another example of treatment methods and treatment systems for plant effluent.

FIG. 3 is a process flow diagram that shows yet another example of treatment methods and treatment systems for plant effluent.

FIG. 4 is a process flow diagram that shows yet another example of treatment methods and treatment systems for plant effluent.

FIG. 5 is a process flow diagram that schematically shows the treatment system used in Working Example 2.

### EXPLANATION OF NUMERICAL SYMBOLS

1 Means of preliminary treatment
2 Means of mixing
3 Membrane bioreactor tank
4 Anoxic tank
5 Anaerobic biological treatment tank
6 Post-treatment reverse osmosis membrane separation device
7 Distillation column
8 Pretreatment reverse osmosis membrane separation device
11 Plant effluent
12 Preliminary treatment effluent
13 Mixing treatment effluent
14 Aerobically treated water
15 Excess sludge
16 Pretreated water
18 Post-treatment RO filtrate
19 Post-treatment RO concentrate
21 Microorganism activating agent
22, 23 pH controlling agent
31 Treated water containing acidic, oxygen-containing hydrocarbons
32 Organic compounds excluding acidic, oxygen-containing hydrocarbons
33 Pretreatment RO filtrate
34 Pretreatment RO concentrate

### DETAILED DESCRIPTION

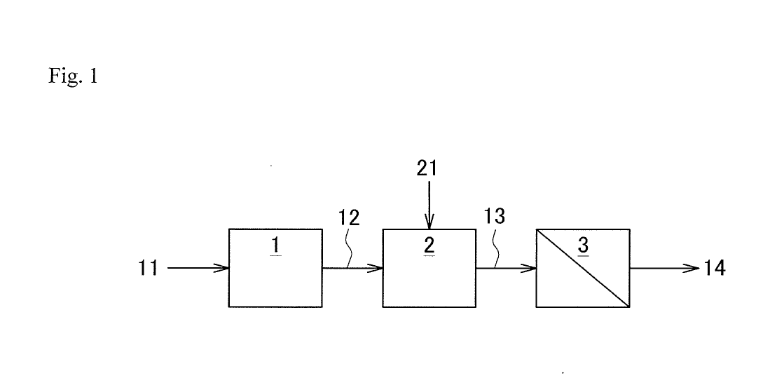

FIG. 1 is a process flow diagram that shows an example of treatment methods and treatment systems for plant effluent. In FIG. 1, symbols 1, 2 and 3 denote a means of preliminary treatment, means of mixing, and membrane bioreactor tank, respectively.

Our plant effluent treatment systems always have a means of mixing 2 and a membrane bioreactor tank 3. They may also feature a means of preliminary treatment 1 in the upstream of the means of mixing 2 as shown in FIG. 1.

The means of mixing 2 is a means to mix a microorganism activating agent 21 into the plant effluent 11 or preliminary treatment effluent 12 discharged from the means of preliminary treatment 1, and may be a standalone mixing tank, static mixer or some other mixing device. Addition of the microorganism activating agent 21 makes it possible to activate the aerobic microorganisms (activated sludge) in the membrane bioreactor tank 3 and increase their cohesion.

Placed downstream of the means of mixing 2, the membrane bioreactor tank 3 provides the mixing treatment effluent 13 with aerobic biological treatment and solid-liquid separation treatment. A normally used aerobic biological treatment device, the membrane bioreactor tank 3 features an aeration tube that supplies air into the tank and a means of solid-liquid separation comprising a separation membrane or membranes. The separation membrane may be any used as long as its pore diameter is smaller than the size of the aerobic microorganisms. Examples include an ultrafiltration (UF) membrane and microfiltration (MF) membrane.

In the membrane bioreactor tank 3, the microorganism activating agent 21 activates the activated sludge and increases its cohesion. This makes it possible to minimize degradation of the activity of activated sludge and activated sludge deactivation (disintegration).

For this reason, we believe that the deactivation of the activated sludge or fouling of the separation membrane due to its disintegration/pulverization will not occur in the case of the means of preliminary treatment being a distillation column as described hereinafter. Similarly, if the means of preliminary treatment is an anaerobic biological treatment tank, we believe that fouling of the separation membrane by anaerobic treatment-derived suspended solids can be avoided, thanks to the digestion of suspended solids by activated sludge that is highly activated. In either case, the operational flux of the separation membrane can be raised above traditional levels.

The water that has been biologically treated in the membrane bioreactor tank 3 is filtered through a separation membrane before being discharged as aerobically treated water 14. The aerobically treated water 14 may be used as process water (reused water) for a cooling tower or the like, sprinkler water, toilet flushing water, or the like. It may also be fed to a post-treatment reverse osmosis membrane separation device for further purification.

In our plant effluent treatment systems, the means of preliminary treatment 1 may be chosen from any normal means of treatment for plant effluent. The means of preliminary treatment 1 may preferably contain at least one facility chosen from an anaerobic biological treatment tank, distillation column, wet oxidation device, means of dilution, means of screen filtration, means of carrier filtration, means of sand filtration, means of pH control, means of oil removal treatment, and means of activated carbon treatment. More preferably, the means of preliminary treatment 1 may be able to treat plant effluent 11 through anaerobic biological treatment and/or distillation and decompose and/or remove organic compounds contained in the plant effluent 11. The water treated with the means of preliminary treatment 1 is discharged as preliminary treatment effluent 12.

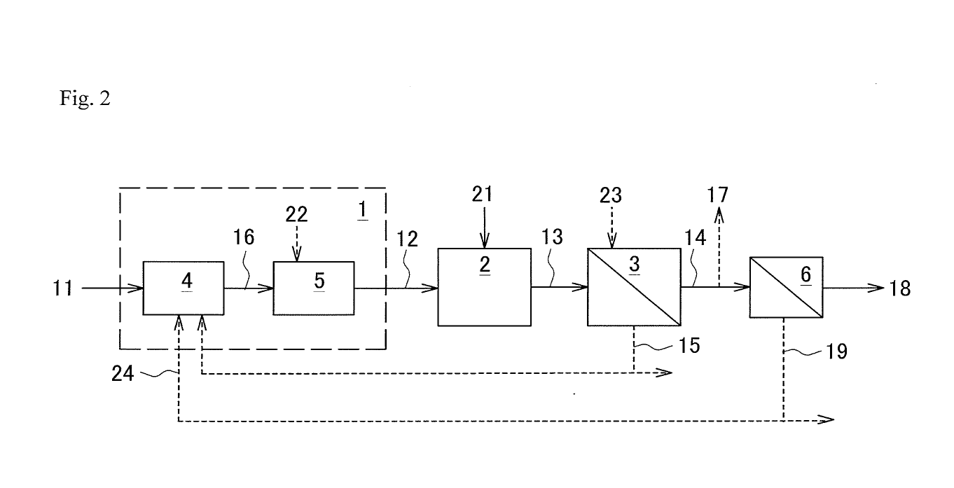

FIG. 2 is a process flow diagram that shows another example of treatment methods and treatment systems for plant effluent. In FIG. 2, the means of preliminary treatment 1 comprises an anoxic tank 4 and an anaerobic biological treatment tank 5. Both the anoxic tank 4 and the anaerobic biological treatment tank 5 are treatment tanks that provide anaerobic biological treatment, and the one on the upstream side is called an “anoxic tank,” with the one on the downstream side called an “anaerobic biological treatment tank.”

The anoxic tank 4 features a means of exposure to anaerobic gas and puts the interior of the tank into near anoxic conditions by exposing the plant effluent 11 to the anaerobic gas to provide organic compounds with anaerobic biological treatment. The anoxic tank 4 may also have a means of adding part of the excess sludge 15 and part of the RO concentrate and a means of adding compounds containing nitrogen and phosphorus components. The uptake of excess sludge (activated sludge), RO concentrate and nitrogen, phosphorus and other components as nutrients activates the anaerobic microorganisms in the anoxic tank 4 and facilitates the anaerobic biological treatment of organic compounds.

Placed downstream of the anoxic tank 4, the anaerobic biological treatment tank 5 provides pretreated water 16 discharged from the anoxic tank 4 with further anaerobic biological treatment. The anaerobic biological treatment tank 5 may have a means of adding a pH controlling agent 22 to adjust pH to levels favorable to anaerobic microorganisms. It is preferable that the anaerobic biological treatment tank 5 be an upflow anaerobic sludge blanket (UASB). A UASB is a normally used anaerobic biological treatment device with high biodegradation efficiency. The water treated in the anaerobic biological treatment tank 5 is discharged as preliminary treatment effluent 12. The preliminary treatment effluent 12 is provided with aerobic biological treatment and solid-liquid separation treatment in a membrane bioreactor tank 3, as with the case of the example shown in FIG. 1. The membrane bioreactor tank 3 may have a means of adding pH controlling agent 23 to adjust pH to levels favorable to aerobic microorganisms.

In FIG. 2, the post-treatment reverse osmosis membrane separation device 6 is placed downstream of the membrane bioreactor tank 3 to separate part of the aerobically treated water 14 into a post-treatment RO filtrate 18 and a post-treatment RO concentrate 19. The post-treatment RO filtrate 18 may be used as raw water for pure water or drinking water, makeup water for a boiler/cooling tower, agricultural water, or the like. Part 24 of the post-treatment RO concentrate may be returned from the reverse osmosis membrane separation device 6 to the anoxic tank 4 and added as a source of nutrients for the microorganisms.

Furthermore, at least part of the excess sludge 15 removed from the membrane bioreactor tank 3 may be returned to the anoxic tank 4, and a means of solubilizing (not shown on the drawing) designed to render the excess sludge (activated sludge) soluble may be placed midway along the return piping.

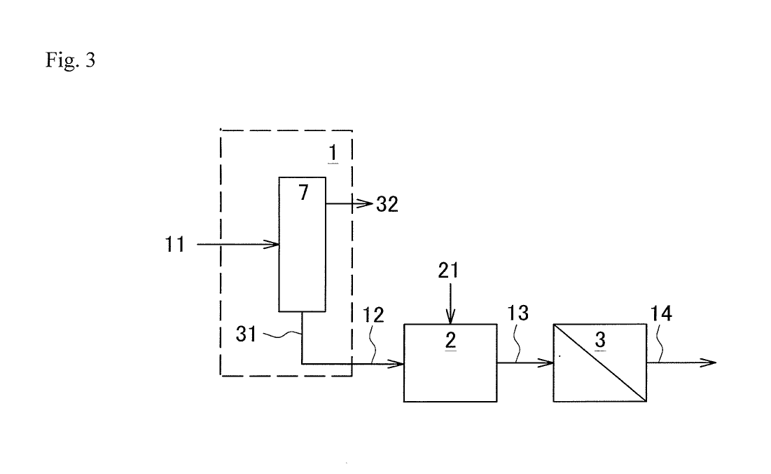

FIG. 3 is a process flow diagram that shows yet another example of treatment methods and treatment systems for plant effluent. In FIG. 3, the means of preliminary treatment 1 comprises a distillation column 7.

The distillation column 7 is designed to remove organic compounds 32 other than, for example, acidic, oxygen-containing hydrocarbons from the plant effluent 11 by distilling it and discharge the treated water containing acidic, oxygen-containing hydrocarbons 31 as preliminary treatment effluent 12. The preliminary treatment effluent 12 goes on to be treated in the same manner as the example shown in FIG. 1.

Examples of acidic, oxygen-containing hydrocarbons include formic acid, acetic acid, propionic acid, butyric acid, valeric acid, caproic acid, enanthic acid, caprylic acid, and other organic acids. Organic compounds excluding acidic, oxygen-containing hydrocarbons 32 comprise non-acidic, oxygen-containing hydrocarbons and non-oxygen-containing hydrocarbons, and their examples include alcohol, aldehyde, ketone, and alkane.

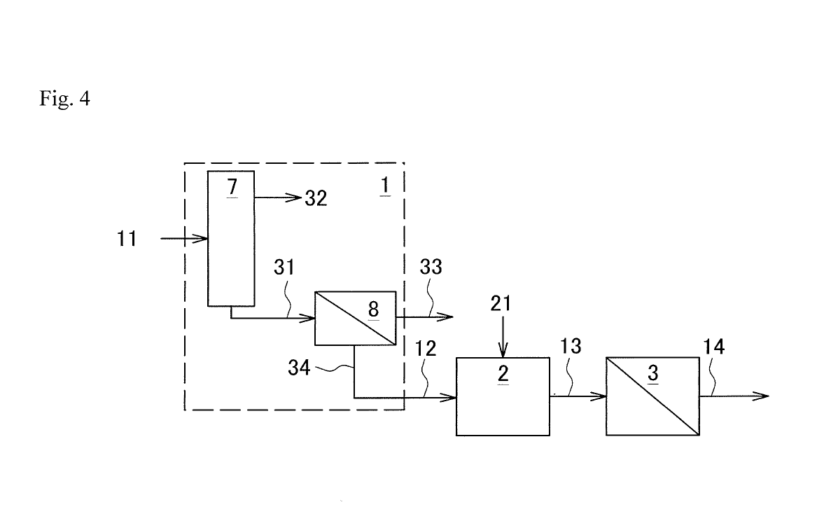

FIG. 4 is a process flow diagram that shows yet another example of treatment methods and treatment systems for plant effluent, wherein the means of preliminary treatment 1 comprises a distillation column 7 and a pretreatment reverse osmosis membrane separation device 8.

In FIG. 4, the distillation column 7 is designed to remove organic compounds 32 other than, for example, acidic, oxygen-containing hydrocarbons from the plant effluent 11 by distilling it and discharge the treated water containing acidic, oxygen-containing hydrocarbons 31. The pretreatment reverse osmosis membrane separation device 8, placed downstream of the distillation column 7, then separates the treated water containing acidic, oxygen-containing hydrocarbons 31 into a pretreatment RO filtrate 33 and a pretreatment RO concentrate 34. The pretreatment RO concentrate 34 is discharged as the preliminary treatment effluent 12 and goes on to be treated in the same manner as the example shown in FIG. 1.

In the examples shown in FIGS. 3 and 4, a post-treatment reverse osmosis membrane separation device 6 may be placed downstream of the membrane bioreactor tank 3 in the same manner as the example shown in FIG. 2. This makes it possible to separate at least part of the aerobically treated water 14 into a post-treatment RO filtrate 18 and post-treatment RO concentrate 19.

Plant effluent targeted for treatment is effluent containing organic compounds as discharged from chemical plants, petroleum plants and petrochemical plants. Examples of plant effluent discharged from a chemical plant include wastewater as a by-product of chemical reactions such as by-product water generated at a Fischer-Tropsch process plant, and cleaning water used to refine a main product. Water used to wash reaction devices and equipment is also suitable for treatment.

Such plant effluent containing mid to high-concentration organic compounds cannot be used as raw water for pure water or drinking water or agricultural water. Its use as industrial water is also limited. Organic compounds comprise low hydrocarbons and water-soluble oxygen-containing hydrocarbons, and their examples include alkane, alcohol, ketone, aldehyde, and organic acids. These organic compounds may occur singularly or in combination.

Unlike wastewater from a food plant, restaurant, kitchen, or the like, this plant effluent contains hardly any main nutrients for microorganisms as agents for biological treatment. Namely, plant effluent from chemical plants, petroleum plants and petrochemical plants contains hardly any carbohydrate, fat, protein, nitrogen, phosphorus or trace metal elements such as potassium, sodium and calcium. We observed that attempts to provide such plant effluent with membrane bioreactor after subjecting it to anaerobic biological treatment and/or distillation lead to problems such as fouling of the separation membrane. The problem is caused by deactivation and disintegration/pulverization of activated sludge due to an inability to increase the activity of microorganisms and an inadequacy of the biological treatment of anaerobic treatment-derived organic compounds. We prevent deactivation or pulverization (disintegration) of activated sludge, minimize fouling of the separation membrane, and raise its operational flux by mixing a microorganism activating agent into the plant effluent after providing it with anaerobic biological treatment and/or distillation and thus increasing the activity of the activated sludge.

In our treatment methods, the plant effluent 11 is first added with a microorganism activating agent 21 in a mixing treatment step and then provided with aerobic biological treatment in an aerobic treatment step, followed by solid-liquid separation treatment, to be reclaimed as aerobically treated water 14. First, the mixing treatment step and aerobic treatment step are described.

The microorganism activating agent 21 added in the mixing treatment step comprises nutrients taken up by aerobic microorganisms and/or fibrous material. Examples of the microorganism activating agent 21 preferably include domestic wastewater, artificial sewage, effluent from a food or food processing plant, kitchen wastewater, and supernatant liquor of a sludge digestion tank. It is particularly preferable to use domestic wastewater. Domestic wastewater comprises gray water and/or human excrement. Gray water, in turn, comprises kitchen wastewater, bath wastewater, laundry wastewater, and the like. Examples of human excrement include toilet flushing water, which may contain toilet paper and other fibrous materials. The addition of a microorganism activating agent 21 can activate the aerobic microorganisms and improve treatment efficiency above traditional levels at no cost.

The microorganism activating agent 21 preferably contains carbohydrate, fat, protein, nitrogen, phosphorus and fibrous material. These components help activate aerobic microorganisms. Fibrous material helps increase the cohesion of the activated sludge by acting as nuclei. For this reason, it helps minimize the disintegration and pulverization of the activated sludge. Examples of a microorganism activating agent that can be easily prepared to contain nutrients as described above include artificial sewage. Table 1 shows the composition of typical artificial sewage.

TABLE 1
Composition of Artificial Sewage
(Organic matter)

| | | |
|---|---|---|
| Peptone | 20-50 | mg/l |
| Yeast extract | 20-50 | mg/l |
| Meat juice extract | 20-50 | mg/l |
| Glucose | 60-150 | mg/l |

(Ammonium salts)

| | | |
|---|---|---|
| Ammonium chloride | 76.4-191 | mg/l |

(Inorganic salts)

| | | |
|---|---|---|
| Potassium chloride | 10-25 | mg/l |
| Sodium chloride | 5-12.5 | mg/l |
| Magnesium sulfate heptahydrate | 3-7.5 | mg/l |
| Calcium chloride dihydrate | 3-7.5 | mg/l |
| Potassium dihydrogen phosphate | 14-35 | mg/l |
| Sodium hydrogen carbonate | 200-500 | mg/l |

The microorganism activating agent 21 may be either liquid or solid (e.g., powder or granular). The microorganism activating agent 21 may be directly mixed into the preliminary treatment effluent or used as a solution/suspension produced by dissolving/dispersing it in water or some other medium.

It is preferable that the microorganism activating agent 21 has a pH of 6.0-8.0, a biochemical oxygen demand (BOD) of 60-1000 mg/l, a total nitrogen content of 15-100 mg/l, and a total phosphorus content of 1.5-15 mg/l. The microorganism activating agent 21 may also contain components other than those listed above as far as they do not inhibit the activity of microorganisms.

Total nitrogen content is the aggregate total of the contents of organic nitrogen, ammoniacal nitrogen, nitrous acid nitrogen and nitric acid nitrogen, while total phosphorus content is the content of phosphoric acid phosphorus. Biochemical oxygen demand (BOD) and the contents of organic nitrogen, ammoniacal nitrogen, nitrous acid nitrogen, nitric acid nitrogen and phosphoric acid phosphorus are found through analyses conducted in accordance with JIS K0201 21, JIS K0102 44, JIS K0102 42, JIS K0102 43.1, JIS K0102 43.2 and JIS K0102 46.1, respectively.

The ratio of mixing between the preliminary treatment effluent 12 and the microorganism activating agent 21 in the mixing treatment step is preferably 1-50 parts by weight, and more preferably 5-15 parts by weight, of microorganism activating agent 21 for 100 parts by weight of preliminary treatment effluent 12.

In the mixing treatment step, the microorganism activating agent 21 is added, and the treated water, which contains nutrients for activated sludge (aerobic microorganisms) and fibrous material as nuclei of activated sludge flocs, is discharged as mixing treatment effluent 13 and transferred to the aerobic treatment step.

In the aerobic treatment step, the mixing treatment effluent 13 is introduced into the membrane bioreactor tank 3 and provided with aerobic biological treatment and solid-liquid separation treatment. The pH of the membrane bioreactor tank 3 is adjusted preferably to 6.5-8.0 and more preferably to 7.0-8.0. The means of controlling pH is subject to no restrictions, and any normal pH controlling method may be used, with an acid or base-based pH controlling agent 23 added as needed. As the membrane bioreactor tank 3, it is preferable to use a membrane bioreactor (MBR). Featuring an aeration tube, an MBR blows air and decomposes/removes the organic compounds that remain in the mixing treatment effluent 13 through aerobic biological treatment. The activated sludge in the membrane bioreactor tank 3 becomes activated by feeding on the abundant nutrients contained in the mixing treatment effluent 13. It is surmised that, for this reason, most of the anaerobic treatment-derived suspended solids sometimes generated in the preliminary treatment step as described hereinafter are digested. Also, since fibrous material is contained, the activated sludge easily coagulates, and this minimizes its disintegration/pulverization.

The effluent from the aerobic biological treatment step is then passed through a separation membrane built into the MBR to remove activated sludge through solid-liquid separation, and the filtrate is discharged as aerobically treated water 14.

Since our methods and systems are capable of eliminating most of the anaerobic treatment-derived suspended solids in the membrane bioreactor tank 3 and keeping the cohesion of the activated sludge high, it is possible to minimize fouling of the separation membrane and dramatically improve its operational flux. For example, the treatment flux of a separation membrane, which had been around 0.2 m³/m²/day without the addition of domestic wastewater, increased more than three-fold to 0.6-0.65 m³/m²/day when domestic wastewater was added as described above.

If activated sludge grows excessively in the membrane bioreactor tank 3, a portion may be removed as excess sludge 15 to control sludge concentration. Furthermore, part of the excess sludge 15 may be used as a source of nutrients for anaerobic microorganisms. To this end, it is preferable to provide excess sludge with solubilization treatment, i.e., destroy or dissolve the shells (cell membranes) of aerobic microorganisms that constitute activated sludge to make it easier for anaerobic microorganisms to absorb as nutrients. As a method to provide the excess sludge with solubilization treatment, any normal method may be used. Examples include the treatment of excess sludge with a base such as a water solution of sodium hydroxide, crushing treatment thereof using a wet mill, freezing treatment thereof, ultrasonic treatment thereof, and ozone treatment thereof.

The preliminary treatment step may contain at least one method chosen from anaerobic biological treatment, distillation, wet oxidation, dilution, screen filtration, carrier filtration, sand filtration, pH control, oil separation and removal treatment, and activated carbon treatment. Of these, it is preferable to use anaerobic biological treatment/distillation treatment designed to decompose/remove organic compounds contained in the plant effluent 11.

It is preferable that the preliminary treatment step comprise a treatment step that decomposes organic compounds contained in the plant effluent through anaerobic treatment as shown in FIG. 2 and/or another treatment step that removes organic compounds contained in the plant effluent through distillation as shown in FIGS. 3 and 4.

The preliminary treatment step shown in FIG. 2 comprises anaerobic treatment based on an anoxic tank 4 and anaerobic treatment based on an anaerobic biological treatment tank 5. In the anoxic tank 4, the plant effluent 11 is fed and exposed to anaerobic gas to deprive it of oxygen, while inducing decomposition reaction based on agitation and mixing of anaerobic microorganisms. Anaerobic gas is a gas that does not contain oxygen, and its examples include nitrogen, methane and carbon dioxide. These gases may be used singularly or as a mixed gas of two or more. A mixed gas containing methane and carbon dioxide is preferable. In this regard, a mixed gas containing methane and carbon dioxide generated from a treatment method may be used.

By biodegrading organic compounds contained in the plant effluent under such anoxic conditions, anaerobic microorganisms cut the main chains of organic compounds and turn them into lower molecular-weight compounds or decompose them into organic acids. In the anoxic tank 4, an RO concentrate, excess sludge and compounds containing nitrogen and phosphorus components may be added as sources of nutrients. Examples of nitrogen components include urea and ammonium salts. As phosphorus components, phosphoric acid and phosphates, for example, are preferable. The effluent from the anoxic tank 4 is discharged as pretreated water 16.

The pretreated water 16 is then introduced into the anaerobic biological treatment tank 5 to provide further anaerobic biological treatment. When the pretreated water 16 is introduced into the anaerobic biological treatment tank 5, its pH is adjusted preferably to 5.5-7.0, and more preferably to 6.0-6.7, using a means of pH control. The means of pH control is subject to no restrictions, and any normal pH controlling method may be used, with a base-based pH controlling agent 22 added as needed. The pH controlling agent 22 may be a water solution of NaOH. By adding a base-based pH controlling agent 22, the activity of anaerobic microorganisms can be increased. Although the most optimal pH for the activity of anaerobic microorganisms is 7.0-7.5, adjusting pH to 6.0-6.7 is advantageous in that it can reduce the amount of pH controlling agent 22 used and, hence, its purchase cost without significantly impairing the activity of anaerobic microorganisms compared to adjusting pH to 7.0-7.5. It can also reduce the amount of sodium ion contained in the aerobically treated water 14, thus making the reuse of the aerobically treated water 14 easier.

A treatment tank of the upflow anaerobic sludge blanket (UASB) type is preferably used as the anaerobic biological treatment tank 5. Organic compounds decomposed through anaerobic biodegradation in the anaerobic biological treatment tank 5 are further decomposed into methane and carbon dioxide and discharged as a mixed gas. Any surplus anaerobic microorganisms resulting from excessive growth in the anaerobic biological treatment tank 5 may be removed as needed and stored for future reuse. The effluent from the anaerobic biological treatment tank 5 is discharged as preliminary treatment effluent 12. The preliminary treatment effluent 12 then undergoes the addition of a microorganism activating agent 21 in the mixing treatment step, followed by aerobic biological treatment and solid-liquid separation treatment in the aerobic treatment step as described above, before being reclaimed as aerobically treated water 14.

In FIG. 2, at least part of the aerobically treated water 14 is fed to the post-treatment reverse osmosis membrane separation device 6 as a post-treatment RO step. The rest 17 of the aerobically treated water 14 may be used as process water for a cooling tower or the like (reused water). The portion of the aerobically treated water 14 fed to the post-treatment reverse osmosis membrane separation device 6 is purified as post-treatment RO filtrate 18 by removing dissolved matter. The post-treatment RO filtrate 18 may be used as raw water for pure water or drinking water or agricultural water. It may also be used for boiler feedwater, cooling water, or industrial water. The dissolved matter removed from the aerobically treated water 14 is discharged as post-treatment RO concentrate 19. The dissolved matter comprises residual organic compounds, nitrogen compounds, phosphorus compounds, and the like. At least part 24 of the post-treatment RO concentrate 19 may be returned to the anoxic tank 4 in the pretreatment step. Since the post-treatment RO concentrate 19 contains nitrogen compounds and phosphorus compounds, it can be utilized as a source of nutrients for anaerobic microorganisms and aerobic microorganisms.

The rest of the excess sludge 15 may be introduced into a methane fermentation tank for anaerobic biological treatment. This decomposes the excess sludge into a mixed gas containing methane and carbon dioxide and discharges them. The mixed gases containing methane and carbon dioxide that are discharged from the anaerobic biological treatment tank and methane fermentation tank may be returned to the anoxic tank and used as anaerobic gas for anaerobic gas exposure treatment. This minimizes the cost of biological treatment. Alternatively, these mixed gases may be returned to the main plant comprising a chemical plant, petroleum plant or petrochemical plant. The mixed gas discharged from the anaerobic biological treatment tank has a CH₄/CO₂ ratio of 8/2-7/3, and can therefore be readily used as raw material for the reforming reaction in the Fischer-Tropsch process, which is a technique to manufacture a synthetic gas with a H₂/CO ratio of 2 from natural gas.

In the example shown in FIG. 3, the preliminary treatment step comprises a distillation step designed to accept and distill plant effluent 11 in a distillation column 7. In the distillation column 7, the plant effluent 11 is distilled with steam, whereby organic compounds with a boiling point lower than the boiling point of water are removed. The organic compounds with a boiling point lower than the boiling point of water comprise organic compounds excluding acidic, oxygen-containing hydrocarbons 32. The treated water containing acidic, oxygen-containing hydrocarbons 31, on the other hand, mainly contains acidic, oxygen-containing hydrocarbons as organic compounds, but may also contain hydrocarbons excluding acidic, oxygen-containing hydrocarbons with a boiling point higher than the boiling point of water. This treated water 31 is discharged as preliminary treatment effluent 12, which then undergoes the addition of a microorganism activating agent 21 in the mixing treatment step, followed by aerobic biological treatment and solid-liquid separation treatment in the aerobic treatment step, before being reclaimed as aerobically treated water 14.

Addition of a microorganism activating agent 21 to the treated water containing acidic, oxygen-containing hydrocarbons 31 can prevent deactivation and pulverization of the activated sludge in the membrane bioreactor tank 3.

In the example shown in FIG. 4, the preliminary treatment step comprises a distillation and membrane separation step designed to distill plant effluent 11 in a distillation column 7 and then provide the effluent with membrane separation treatment in a pretreatment reverse osmosis membrane separation device 8. Distillation in the distillation column 7 is as described above. The effluent discharged from the distillation column 7, i.e., the treated water containing acidic, oxygen-containing hydrocarbons 31, is fed to the pretreatment reverse osmosis membrane separation device 8 to separate it into a pretreatment RO filtrate 33 and a pretreatment RO concentrate 34. The pretreatment RO filtrate 33 is purified reclaimed water, and may be used as raw water for pure water or drinking water or agricultural water. The pretreatment RO concentrate 34 is discharged as preliminary treatment effluent 12 and then undergoes the addition of a microorganism activating agent 21 in the mixing treatment step, followed by aerobic biological treatment and solid-liquid separation treatment in the aerobic treatment step, before being reclaimed as aerobically treated water 14

Traditionally, the pretreatment RO concentrate 34 had stronger action than the treated water containing acidic, oxygen-containing hydrocarbons 31 discharged from the distillation column 7 in terms of inactivating and disintegrating/pulverizing activated sludge. However, addition of the microorganism activating agent 21 can prevent deactivation and pulverization of the activated sludge in the membrane bioreactor tank 3.

Though not shown in FIG. 3 or 4, at least part of the aerobically treated water 14 may be fed to the post-treatment reverse osmosis membrane separation device 6 as a post-treatment RO step. The portion of the aerobically treated water 14 fed to the post-treatment reverse osmosis membrane separation device 6 may be separated into a post-treatment RO filtrate 18, which is free of dissolved matter, and a post-treatment RO concentrate 19, which is condensed dissolved matter.

Our methods and systems are described in more detailed below by way of working examples. However, this disclosure is not at all limited to these working examples.

### WORKING EXAMPLES

### Working Example 1

Using a plant effluent treatment system with a configuration as shown in FIG. 2, a purification treatment of plant effluent generated as a byproduct of the Fischer-Tropsch process was conducted. As the anaerobic biological treatment tank 5, a UASB was employed, while an MBR was used as the membrane bioreactor tank 3.

The water quality of plant effluent 11 is shown under the “Plant effluent” column of Table 2. The plant effluent 11 was fed to the anoxic tank 4 at a flow rate of 19.8 mL/min and anoxically treated. The pretreated water 16 discharged from the anoxic tank 4 was then introduced into the anaerobic biological treatment tank 5, along with 0.4 mL/min of a 5% water solution of NaOH. Through this, the pretreated water 16 was detained in the anaerobic biological treatment tank 5 (detention time: 40.8 hours) and provided with anaerobic biological treatment, while pH was kept at 7.0-7.5. The water quality of the preliminary treatment effluent 12 discharged from the anaerobic biological treatment tank 5 is shown under the “UASB-treated water” column of Table 2. The water quality of the preliminary treatment effluent 12 shows an improvement in terms of a dramatic reduction in the content of alcohol and other non-acidic, oxygen-containing hydrocarbons and in CODcr. However, suspended solids (SS) increased 55 fold.

The preliminary treatment effluent 12 discharged from the anaerobic biological treatment tank 5 was fed to a means of mixing 2 and mixed with 2 mL/min of domestic wastewater 21 with water quality as shown in Table 3. The mixing treatment effluent 13 obtained was then introduced into a membrane bioreactor tank 3, along with 0.07 mL/min of 1N hydrochloric acid. Through this, aerobic biological treatment was provided while the pH of the membrane bioreactor tank 3 was kept at 7-8. This was followed by solid-liquid separation via membrane separation. Meanwhile, excess sludge 15 was removed from the membrane bioreactor tank 3, and part was returned to the anoxic tank 4. The water quality of the aerobically treated water 14 discharged from the membrane bioreactor tank 3 is shown under the “MBR-treated water” column of Table 2. The water quality of the aerobically treated water 14 improved in terms of a dramatic reduction in the content of all organic matter components and SS. The treatment flux of membrane separation was high at 0.60 m³/m²/day and stable.

The aerobically treated water 14 obtained was fed to the post-treatment reverse osmosis membrane separation device 6, and the device was operated at a water recovery rate of 65%. The water qualities of the RO-treated post-treatment RO filtrate 18 and the post-treatment RO concentrate 19 are shown under the “RO filtrate” and “RO concentrate” columns of Table 2. The post-treatment RO filtrate 18 was so clean that it met water quality standards for boiler feedwater (48-103 bars) and cooling water under EPA '73. Part 24 of the post-treatment RO concentrate was fed back to the anoxic tank 4.

It was confirmed that the plant effluent treatment method demonstrated in Working Example 1 dramatically increased the treatment flux of membrane separation over Comparative Example 1, described hereinafter, without causing fouling of the separation membrane, thus improving treatment efficiency.

TABLE 2

| | | | UASB-treated | MBR-treated | | |
|---|---|---|---|---|---|---|
| | | Plant effluent | water | water | RO concentrate | RO filtrate |
| Non-acidic, oxygen-containing hydrocarbons | mg/l | 23,000 | ND | ND | ND | ND |
| Acidic, oxygen-containing hydrocarbons | mg/l | 500 | 75 | 35 | 80 | ND |
| Other hydrocarbons | mg/l | 10 | 2 | ND | ND | ND |
| CODcr | mg/l | 41,000 | 1,000 | 60 | 130 | <1 |
| SS | mg/l | 5 | 275 | ND | ND | ND |
| TDS | mg/l | 15 | 3,700 | 6,000 | 16,000 | 80 |
| Chlorine ion | mg/l | ND | ND | 400 | 850 | 1.4 |
| pH | — | 3.1 | 7.2 | 8.0 | 8.6 | 7.7 |

“ND” means undetectable.

TABLE 3

| | | Domestic wastewater | Measurement |
|---|---|---|---|
| | | analysis result | method |
| Organic carbon | mg/l | 27 | JIS K0102 22.1 |
| CODcr | mg/l | 120 | JIS K0102 20 |
| BOD | mg/l | 81.2 | JIS K0201 21 |
| Organic nitrogen | mg/l | 40.9 | JIS K0102 44 |
| Ammoniacal nitrogen | mg/l | 33.6 | JIS K0102 42 |
| Nitrous acid nitrogen | mg/l | Less than 0.02 | JIS K0102 43.1 |
| Nitric acid nitrogen | mg/l | Less than 0.2 | JIS K0102 43.2 |
| Phosphoric acid | mg/l | 2.07 | JIS K0102 46.1 |
| phosphorus | | | |
| TDS | mg/l | 347 | JIS K0102 14.3 |
| SS | mg/l | 51 | JIS K0102 14.1 |

### Comparative Example 1

Using a plant effluent treatment system with a configuration as shown in FIG. 2, a purification treatment of plant effluent generated as a byproduct of the Fischer-Tropsch process was conducted, making sure not to feed domestic wastewater 21, as described in Working Example 1, to the means of mixing 2. As the anaerobic biological treatment tank 5, a UASB was employed, while an MBR was used as the membrane bioreactor tank 3.

The water quality of the plant effluent 11 is shown under the “Plant effluent” column of Table 4. The plant effluent 11 was fed to the anoxic tank 4 at a flow rate of 19.8 mL/min and anoxically treated. The pretreated water 16 discharged from the anoxic tank 4 was then introduced into the anaerobic biological treatment tank 5, along with 0.4 mL/min of a 5% water solution of NaOH. Through this, the pretreated water 16 was detained in the anaerobic biological treatment tank 5 (detention time: 40.8 hours) and provided with anaerobic biological treatment, while pH was kept at 7.0-7.5. The water quality of the preliminary treatment effluent 12 discharged from the anaerobic biological treatment tank 5 is shown under the “UASB-treated water” column of Table 4. The water quality of the preliminary treatment effluent 12 improved in terms of a dramatic reduction in the content of alcohol and other non-acidic, oxygen-containing hydrocarbons and in CODcr. However, suspended solids (SS) increased 40 fold.

The preliminary treatment effluent 12 discharged from the anaerobic biological treatment tank 5 was introduced into a membrane bioreactor tank 3, along with 0.07 mL/min of 1N hydrochloric acid. Through this, aerobic biological treatment was provided while the pH of the membrane bioreactor tank 3 was kept at 7-8. This was followed by solid-liquid separation via membrane separation. Meanwhile, excess sludge 15 was removed from the membrane bioreactor tank 3, and part was returned to the anoxic tank 4. The water quality of the aerobically treated water 14 discharged from the membrane bioreactor tank 3 is shown under the “MBR-treated water” column of Table 4. Although the water quality of the aerobically treated water 14 shows an improvement in terms of a reduction in the content of all organic matter components and SS, the treatment flux of membrane separation fell sharply to 0.20 m³/m²/day.

The aerobically treated water 14 obtained was fed to the post-treatment reverse osmosis membrane separation device 6, and the device operated at a water recovery rate of 65%. The water qualities of the RO-treated post-treatment RO filtrate 18 and the post-treatment RO concentrate 19 are shown under the “RO filtrate” and “RO concentrate” columns of Table 4. Part 24 of the post-treatment RO concentrate was fed back to the anoxic tank 4.

TABLE 4

| | | | UASB-treated | MBR-treated | | |
|---|---|---|---|---|---|---|
| | | Plant effluent | water | water | RO concentrate | RO filtrate |
| Non-acidic, oxygen-containing hydrocarbons | mg/l | 23,000 | ND | ND | ND | ND |
| Acidic, oxygen-containing hydrocarbons | mg/l | 500 | 55 | 25 | 50 | ND |
| Other hydrocarbons | mg/l | 10 | 2 | ND | ND | ND |
| CODcr | mg/l | 41,000 | 800 | 40 | 90 | <1 |
| SS | mg/l | 5 | 200 | ND | ND | ND |
| TDS | mg/l | 15 | 3,500 | 6,000 | 15,000 | 75 |
| Chlorine ion | mg/l | ND | ND | 420 | 880 | 1.7 |
| pH | — | 3.1 | 7.0 | 8.3 | 8.6 | 7.8 |

“ND” means undetectable.

### Working Example 2

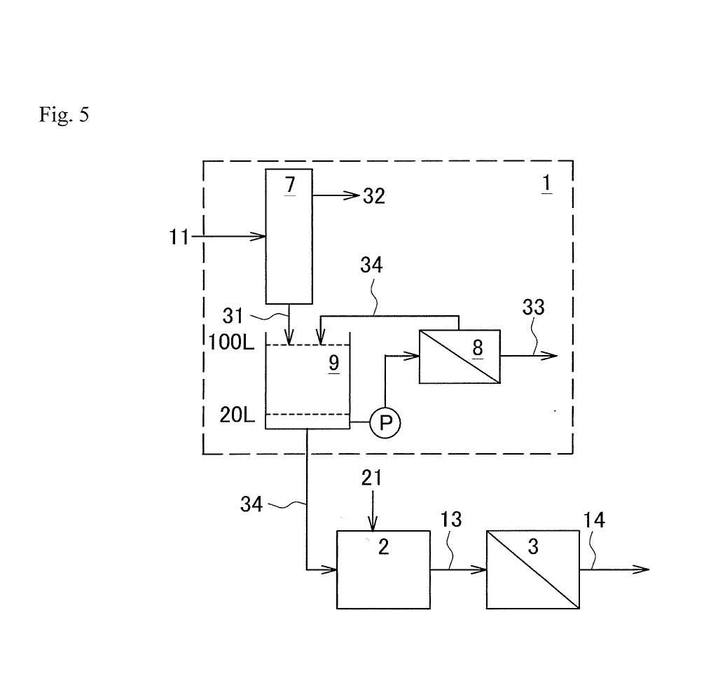

Using a plant effluent treatment system with a configuration as shown in FIG. 5, a purification treatment of plant effluent generated as a byproduct of the Fischer-Tropsch process was conducted. As the means of preliminary treatment 1, a distillation column 7 and a pretreatment reverse osmosis membrane separation device 8 were employed, while an MBR was used as the membrane bioreactor tank 3.

The water quality of the plant effluent 11 is shown under the “Plant effluent” column of Table 5. The plant effluent 11 was distilled in the distillation column 7, and 100 L of treated water containing acidic, oxygen-containing hydrocarbons 31 was detained in the water tank 9. The water quality of the treated water 31 is shown under the “Distillation-treated water” column of Table 5. A hundred milliliters of a 25% water solution of NaOH was added to the 100 L of detained water to adjust pH to 5.5. The pH-adjusted detained water was fed to the pretreatment reverse osmosis membrane separation device 8 to separate it into a pretreatment RO filtrate 33 and a post-treatment RO concentrate 34 to achieve a concentrate/filtrate flow rate ratio of 4.9 L/min/0.9 L/min. The water qualities of the pretreatment RO filtrate 33 and the pretreatment RO concentrate 34 are shown under the “Pretreatment RO filtrate” and “Pretreatment RO concentrate” columns of Table 5. To return the pretreatment RO concentrate 34 to the water tank 9 in a feedback operation, the pretreatment RO was operated until the volume of water in the water tank 9 reached 20 L (five-fold concentration). By running this five-fold concentration operation several times, 90 L of pretreatment RO concentrate 34 was detained in the means of mixing 2 as preliminary treatment effluent.

This 90 L of preliminary treatment effluent was mixed with 10 L of domestic wastewater 21 to turn it into mixing treatment effluent 13 (a domestic wastewater adding rate of 10 weight %). The water quality of the domestic wastewater 21 is shown under the “Domestic wastewater” column of Table 5, while the water quality of the mixing treatment effluent 13 is shown under the “Mixing treatment effluent” column of Table 5.

The mixing treatment effluent 13 obtained was fed to the membrane bioreactor tank 3 (capacity 30 L) and passed through a membrane filter comprising two 0.03 m² flat membranes at a flow rate of 32.4 mL/min under an operation pattern of 9 minutes of filtration and 1 minute of pausing. The filter could be operated stably at a flux of 0.70 m³/m²/day. The water quality of the aerobically treated water 14 discharged from the membrane bioreactor tank 3 is shown under the “MBR-treated water” column of Table 5.

At this operational flux, the filter was continuously operated for 30 days, and the transmembrane pressure difference rose to 15 kPa. The control value for transmembrane pressure difference was 20 kPa or less.

It was confirmed that the plant effluent treatment method demonstrated in Working Example 2 dramatically increased the treatment flux of membrane separation over Comparative Example 2, described hereinafter, and improved treatment efficiency.

TABLE 5

| | | | | | | | Mixing | MBR- |
|---|---|---|---|---|---|---|---|---|
| | | Plant | Distillation- | Pretreatment | Pretreatment | Domestic | treatment | treated |
| | | effluent | treated water | RO concentrate | RO filtrate | wastewater | effluent | water |
| Organic carbon | mg/l | 11,000 | 210 | 870 | 20 | 50 | 788 | 5 |
| CODcr | mg/l | 41,000 | 460 | 1,900 | 46 | 120 | 1,722 | 10 |
| SS | mg/l | <1 | <1 | <1 | <1 | 100 | 10 | <1 |
| TDS | mg/l | 15 | 32 | 1,200 | 12 | 340 | 1,114 | 950 |
| Chlorine ion | mg/l | ND | ND | ND | ND | 80 | 8 | 7 |
| pH | — | 3.1 | 3.1 | 5.8 | 4.8 | 7.2 | 6.2 | 6.8 |

“ND” means undetectable.

### Comparative Example 2

Using a plant effluent treatment system with a configuration as shown in FIG. 5, a purification treatment of plant effluent generated as a byproduct of the Fischer-Tropsch process was conducted, making sure not to feed domestic wastewater 21, as described in Working Example 2, to the means of mixing 2 and adding nitrogen and phosphorus nutrients instead. As the means of preliminary treatment 1, a distillation column 7 and a pretreatment reverse osmosis membrane separation device 8 were employed, while an MBR was used as the membrane bioreactor tank 3.

The water quality of the plant effluent 11 is shown under the “Plant effluent” column of Table 6. The plant effluent 11 was distilled in the distillation column 7, and 100 L of treated water containing acidic, oxygen-containing hydrocarbons 31 was detained in the water tank 9. The water quality of the treated water 31 is shown under the “Distillation-treated water” column of Table 6. A hundred milliliters of a 25% water solution of NaOH was added to the 100 L of detained water to adjust pH to 5.5. The pH-adjusted detained water was fed to the pretreatment reverse osmosis membrane separation device 8 to separate it into a pretreatment RO filtrate 33 and pretreatment RO concentrate 34 to achieve a concentrate/filtrate flow rate ratio of 4.9 L/min/0.9 L/min. The water qualities of the pretreatment RO filtrate 33 and the pretreatment RO concentrate 34 are shown under the “Pretreatment RO filtrate” and “Pretreatment RO concentrate” columns of Table 6. To return the pretreatment RO concentrate 34 to the water tank 9 in a feedback operation, the pretreatment RO was operated until the volume of water in the water tank 9 reached 20 L (five-fold concentration). By running this five-fold concentration operation several times, 90 L of pretreatment RO concentrate 34 was detained in the means of mixing 2 as preliminary treatment effluent.

This preliminary treatment effluent was mixed with ammonium chloride (nitrogen source: amount added 287 mg/l) and potassium dihydrogen phosphate (phosphorus source:

amount added 66 mg/l) to turn it into mixed water. The water quality of the mixed water produced through the addition of nitrogen and phosphorus nutrients is shown under the “Mixed water” column of Table 6.

The mixed water obtained was fed to the membrane bioreactor tank 3 (capacity 30 L) and passed through a membrane filter comprising two 0.03 m² flat membranes at a flow rate of 16.2 mL/min under an operation pattern of 9 minutes of filtration and 1 minute of pausing. The filter could be operated at a flux of 0.35 m³/m²/day. The water quality of the aerobically treated water 14 discharged from the membrane bioreactor tank 3 is shown under the “MBR-treated water” column of Table 6.

At this operational flux, the filter was continuously operated for 15 days, and the transmembrane pressure difference rose to 22 kPa. Since this exceeded the control value for transmembrane pressure difference of 20 kPa, chemical cleaning was necessitated, with the frequency of chemical cleaning more than doubling compared to Working Example 2. The treatment speed (flux), on the other hand, was more than halved compared to the working example, while the water quality of the MBR-treated water was generally inferior.

TABLE 6

| | | | Distillation- | Pretreatment | Pretreatment | | MBR-treated |
|---|---|---|---|---|---|---|---|
| | | Plant effluent | treated water | RO concentrate | RO filtrate | Mixed water | water |
| Organic carbon | mg/l | 11,000 | 210 | 870 | 20 | 850 | 10 |
| CODcr | mg/l | 41,000 | 460 | 1,900 | 46 | 1,900 | 25 |
| SS | mg/l | <1 | <1 | <1 | <1 | <1 | <1 |
| TDS | mg/l | 15 | 32 | 1,200 | 12 | 1,553 | 1,300 |
| Chlorine ion | mg/l | ND | ND | ND | ND | 190 | 180 |
| pH | — | 3.1 | 3.1 | 5.8 | 4.8 | 5.8 | 6.6 |

″ND″ means undetectable.

1. A plant effluent treatment method comprising:
a mixing treatment step that mixes a microorganism activating agent into plant effluent containing organic compounds as discharged from a chemical plant, petroleum plant or petrochemical plant and discharges it as mixing treatment effluent, and
an aerobic treatment step that subjects the mixing treatment effluent to aerobic biological treatment and solid-liquid separation treatment in a membrane bioreactor tank.

2. The method according to claim 1, wherein domestic wastewater is the microorganism activating agent.

3. The method according to claim 1, further comprising a preliminary treatment step carried out prior to the mixing treatment step, wherein, in the preliminary treatment step, the plant effluent is treated by at least one method selected from the group consisting of anaerobic biological treatment, distillation, wet oxidation, dilution, screen filtration, carrier filtration, sand filtration, pH control, oil removal treatment, and activated carbon treatment, and discharged as preliminary treatment effluent, and the preliminary treatment effluent is fed to the mixing treatment step.

4. The method according to claim 3, wherein the preliminary treatment step comprises:
a pretreatment step that feeds the plant effluent to an anoxic tank, decomposes organic compounds through anaerobic biological treatment and discharges the effluent as pretreated water, and
an anaerobic treatment step that introduces the pretreated water into an anaerobic biological treatment tank, provides anaerobic biological treatment to further decompose the organic compounds, and discharges the pretreated water as the preliminary treatment effluent.

5. The method according to claim 3, wherein the preliminary treatment step comprises a distillation step that feeds the plant effluent to a distillation column and separates it into treated water containing acidic, oxygen-containing hydrocarbons and organic compounds other than the acidic, oxygen-containing hydrocarbons and the preliminary treatment effluent is treated water containing acidic, oxygen-containing hydrocarbons.

6. The method according to claim 3, wherein the preliminary treatment step comprises:
a distillation step that feeds the plant effluent to a distillation column and separates it into treated water containing acidic, oxygen-containing hydrocarbons and organic compounds other than the acidic, oxygen-containing hydrocarbons, and
a pretreatment RO step that introduces the treated water containing acidic, oxygen-containing hydrocarbons into a pretreatment reverse osmosis membrane separation device and separates it into a pretreatment RO filtrate and pretreatment RO concentrate, wherein
the preliminary treatment effluent is pretreatment RO concentrate.

7. The method according to claim 1, further comprising a post-treatment RO step that introduces at least part of the treated water discharged from the aerobic treatment step into a post-treatment reverse osmosis membrane separation device and separating it into a post-treatment RO filtrate and post-treatment RO concentrate.

8. The method according to claim 1, wherein an activating agent containing carbohydrate, fat, protein, nitrogen, phosphorus and fibrous material is used as the microorganism activating agent.

9. The method according to claim 1, wherein an agent having a pH of 6.0-8.0, a biochemical oxygen demand (BOD) of 60-1000 mg/l, a total nitrogen content of 15-100 mg/l, and a total phosphorus content of 1.5-15 mg/l is used as the microorganism activating agent.

10. A plant effluent treatment system comprising:
a mixing device that mixes a microorganism activating agent into plant effluent containing organic compounds as discharged from a chemical plant, petroleum plant or petrochemical plant and discharges it as mixing treatment effluent, and
a membrane bioreactor tank that subjects the mixing treatment effluent to aerobic biological treatment and solid-liquid separation treatment.

11. The system according to claim 10, further comprising a preliminary treatment means arranged upstream of the mixing device, in the preliminary treatment means the plant effluent is treated using at least one facility selected from the group consisting of an anaerobic biological treatment tank, distillation column, wet oxidation device, dilution device, screen filter, carrier filter, sand filter, pH controller, oil removal treatment device, and activated carbon treatment device, and discharged as preliminary treatment effluent.

12. The system according to claim 11, wherein the preliminary treatment means has an anoxic tank that subjects the plant effluent to anaerobic biological treatment and discharges it as pretreated water, and an anaerobic biological treatment tank that subjects the pretreated water to further anaerobic biological treatment and discharges it as preliminary treatment effluent.

13. The system according to claim 11, wherein the preliminary treatment means has a distillation column that distills the plant effluent and separates it into treated water containing acidic, oxygen-containing hydrocarbons and organic compounds other than the acidic, oxygen-containing hydrocarbons.

14. The system according to claim 13, wherein the preliminary treatment means has a pretreatment reverse osmosis membrane separation device that separates the treated water containing acidic, oxygen-containing hydrocarbons into a pretreatment RO filtrate and pretreatment RO concentrate.

15. The system according to claim 10, further comprising a post-treatment reverse osmosis membrane separation device that separates at least part of the treated water discharged from the membrane bioreactor tank into a post-treatment RO filtrate and post-treatment RO concentrate.
